(19) United States
(12) Patent Application Publication
(10) Pub. No.: US 2026/0168945 A1
(43) Pub. Date: Jun. 18, 2026

(54) SUBSTRATE INSPECTION APPARATUS

(71) Applicant: SAMSUNG ELECTRONICS CO., LTD., Suwon-si (KR)

(72) Inventors: Bumjoo LEE, Suwon-si (KR); Jinwoo LEE, Suwon-si (KR); Jeong Hoi KIM, Suwon-si (KR); Sung Hoon PARK, Suwon-si (KR); Jong Cheon SUN, Suwon-si (KR); Yusin YANG, Suwon-si (KR); Suyoung LEE, Suwon-si (KR)

(73) Assignee: SAMSUNG ELECTRONICS CO., LTD., Suwon-si (KR)

(21) Appl. No.: 19/413,282

(22) Filed: Dec. 9, 2025

(30) Foreign Application Priority Data
Dec. 12, 2024 (KR) 10-2024-0185249

(51) Int. Cl. G01N 23/2206; G01N 23/203; G01N 23/2251

(52) U.S. Cl. CPC G01N 23/2206; G01N 23/203; G01N 23/2251; G01N 2223/102; G01N 2223/401; G01N 2223/6116

(57) ABSTRACT

A substrate inspection apparatus includes a stage for receiving a substrate and a housing provided over the stage. The apparatus also includes an electron gun disposed in the housing for emitting an electron beam onto the substrate, an objective lens disposed under the electron gun in the housing for adjusting a focus of the electron beam, and a deflector provided between the electron gun and the objective lens for deflecting a path of the electron beam. The apparatus further includes a first electron detector disposed on one side of the housing for detecting secondary electrons, a signal converter connected with the first electron detector for converting the first analog signal into a first digital signal, a signal generator for generating a reference signal to control operation of the signal converter and the deflector, and a delay generator for delaying the reference signal.

### CROSS-REFERENCE TO RELATED APPLICATIONS

This application claims priority under 35 U.S.C. § 119 to Korean Patent Application No. 10-2024-0185249 filed on Dec. 12, 2024, in the Korean Intellectual Property Office, the disclosures of which are incorporated by reference herein in their entireties.

### BACKGROUND

Embodiments of the present disclosure described herein relate to a substrate inspection apparatus.

An electron microscope is widely used to investigate defects in various patterns formed on a semiconductor substrate. The electron microscope may observe defects in finer patterns because the electron microscope has higher resolution than an optical microscope. An example of the electron microscope is a scanning electron microscope (SEM). The scanning electron microscope may generate an image or data by scanning a surface of a sample using electrons instead of visible light.

Meanwhile, manufacturing processes of semiconductor devices are becoming increasingly sophisticated as the integration of the semiconductor devices increases. Accordingly, the gap between patterns formed on a semiconductor substrate is gradually decreased, and the time required to detect defects in the patterns is further increased.

### SUMMARY

Embodiments of the present disclosure provide a substrate inspection apparatus for reducing an inspection error.

Embodiments of the present disclosure provide a substrate inspection apparatus for automating correction of an inspection error.

According to an embodiment, a substrate inspection apparatus includes a stage that receives a substrate, a housing provided over the stage, an electron gun that is disposed in the housing and that emits an electron beam onto the substrate, an objective lens that is disposed under the electron gun in the housing and that adjusts a focus of the electron beam, a deflector that is provided between the electron gun and the objective lens and that deflects a path of the electron beam, a first electron detector that is disposed on one side of the housing and that generates a first analog signal based on a result obtained by detecting secondary electrons emitted from the substrate by the electron beam, a signal converter that is connected with the first electron detector and that converts the first analog signal into a first digital signal, a signal generator that is connected with the signal converter and the deflector and that generates a reference signal to control operation of the signal converter and the deflector, and a delay generator that delays the reference signal.

According to an embodiment, a substrate inspection apparatus includes a stage that receives a substrate, a housing provided over the stage, an electron gun that is disposed in the housing and that emits an electron beam onto the substrate, an objective lens that is disposed under the electron gun in the housing and that adjusts a focus of the electron beam, a deflector that is provided between the electron gun and the objective lens and that deflects a path of the electron beam, a first electron detector that is disposed on one side of the housing and that generates a first analog signal based on a result obtained by detecting secondary electrons emitted from the substrate by the electron beam, a signal converter that is connected with the first electron detector and that converts the first analog signal into a first digital signal, a signal generator that is connected with the signal converter and the deflector and that generates a reference signal to control operation of the signal converter and the deflector, a computing system that is connected with the signal converter and that obtains a pattern image for patterns of the substrate, and a delay generator connected between the signal generator and the signal converter and between the signal generator and the deflector, and the delay generator transfers a delayed reference signal to the signal converter and the deflector.

According to an embodiment, a substrate inspection apparatus includes a stage that receives a substrate, a housing provided over the stage, an electron gun that is disposed in the housing and that emits an electron beam onto the substrate, an objective lens that is disposed under the electron gun in the housing and that adjusts a focus of the electron beam, a deflector that is provided between the electron gun and the objective lens and that deflects a path of the electron beam, a first electron detector that is disposed on one side of the housing and that detects secondary electrons emitted from the substrate by the electron beam, a second electron detector that is disposed between the housing and the stage and that detects backscattered electrons scattered from the substrate by the electron beam, a signal converter connected with the first electron detector and the second electron detector, a signal generator that is connected with the signal converter and the deflector and that generates a reference signal having a constant period to control operation of the signal converter and the deflector, a computing system that is connected with the signal converter and that obtains a pattern image for patterns of the substrate, and a delay generator connected between the signal generator and the deflector or between the signal generator and the signal converter. The computing system generates an error correction graph by analyzing sample test images obtained by repeatedly photographing patterns of one area of the substrate. The computing system stores pixel shift values of inspection images for inspection of the patterns of the substrate based on the error correction graph. The delay generator generates delayed reference signals corresponding to the pixel shift values.

### BRIEF DESCRIPTION OF THE FIGURES

The above and other objects and features of the present disclosure will become apparent by describing in detail embodiments thereof with reference to the accompanying drawings.

FIG. 1 is a sectional view of a substrate inspection apparatus according to an embodiment of the present disclosure.

FIG. 2 is a flowchart for explaining an operation process of the substrate inspection apparatus according to an embodiment of the present disclosure.

FIG. 3 is a flowchart for explaining an operation process of the substrate inspection apparatus according to an embodiment of the present disclosure.

FIG. 4 is a view illustrating images taken by the substrate inspection apparatus according to an embodiment of the present disclosure.

FIG. 5 is a view illustrating a portion of an image analyzed by the substrate inspection apparatus according to an embodiment of the present disclosure.

FIGS. 6A and 6B are views illustrating a pixel shift process of the substrate inspection apparatus according to an embodiment of the present disclosure.

FIG. 7 is a graph calculated by the substrate inspection apparatus according to an embodiment of the present disclosure.

FIG. 8 is a graph calculated by the substrate inspection apparatus according to an embodiment of the present disclosure.

FIG. 9 is a flowchart for explaining an operation process of the substrate inspection apparatus according to an embodiment of the present disclosure.

FIG. 10 is a flowchart for explaining an operation process of the substrate inspection apparatus according to an embodiment of the present disclosure.

FIG. 11 is a view illustrating images taken by the substrate inspection apparatus according to an embodiment of the present disclosure.

FIGS. 12A and 12B are views illustrating a pixel shift process of the substrate inspection apparatus according to an embodiment of the present disclosure.

FIG. 13 is a sectional view of a substrate inspection apparatus according to an embodiment of the present disclosure.

FIG. 14 is a sectional view of a substrate inspection apparatus according to an embodiment of the present disclosure.

### DETAILED DESCRIPTION

Hereinafter, embodiments of the present disclosure will be described in more detail with reference to the accompanying drawings.

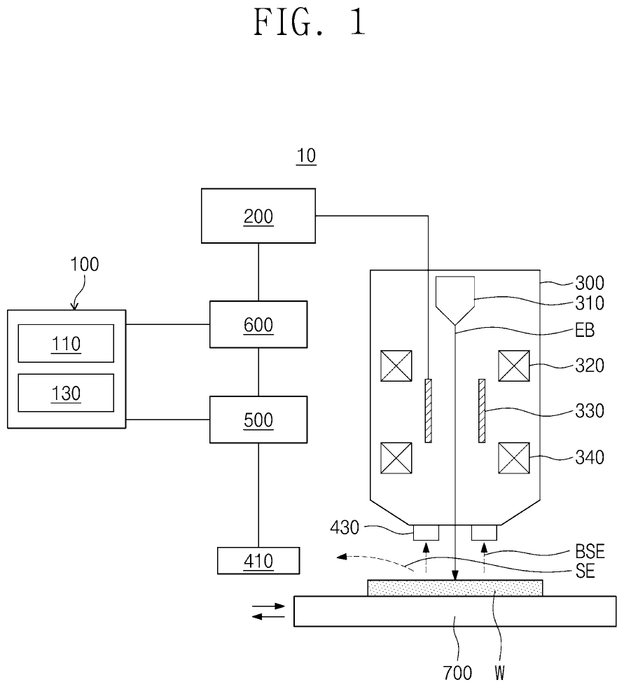

FIG. 1 is a sectional view of a substrate inspection apparatus according to an embodiment of the present disclosure.

Referring to FIG. 1, the substrate inspection apparatus 10 according to an embodiment of the present disclosure may be an inspection apparatus for inspecting defects in various patterns existing on a substrate W. The substrate inspection apparatus 10 may be, for example, a scanning electron microscope (SEM).

More specifically, the substrate inspection apparatus 10 may inspect the substrate W. For example, the substrate inspection apparatus 10 may inspect the substrate W, on which a semiconductor device manufacturing process is performed, using a scanning method. Here, the substrate W may include a silicon on insulator (SOI) substrate, a metal substrate, a glass substrate, and a plastic substrate, as well as a semiconductor substrate made of a semiconductor material. The semiconductor substrate may be, for example, a silicon substrate, a germanium substrate, or a silicon-germanium substrate.

In an embodiment, the substrate inspection apparatus 10 may obtain topographical information of the substrate W, morphological information such as the shapes and sizes of particles constituting the substrate W, and crystallographic information such as the arrangement of atoms in the substrate W by inspecting the substrate W.

In an embodiment, the substrate inspection apparatus 10 may emit an electron beam EB onto a surface of the substrate W and may detect electrons emitted from the substrate W by an interaction between the electron beam EB and the substrate W. Accordingly, the substrate inspection apparatus 10 may inspect defects in various patterns existing on the substrate W. In addition, the substrate inspection apparatus 10 may evaluate various semiconductor device manufacturing processes performed on the substrate W.

The electrons emitted from the substrate W may include, for example, backscattered electrons BSE and secondary electrons SE. The electrons may be generated by elastic scattering or inelastic scattering. For example, the backscattered electrons BSE may be electrons emitted from the surface of the substrate W by the elastic scattering. The backscattered electrons BSE may include information about a structure and a composition near the surface of the substrate W.

For example, the secondary electrons SE may be electrons emitted from the substrate W by the inelastic scattering. The secondary electrons SE may include information about a bumpy structure near the surface of the substrate W. Meanwhile, the electrons emitted from the substrate W are not limited to the backscattered electrons BSE and the secondary electrons SE and may include, for example, Auger electrons or X-rays.

The substrate inspection apparatus 10 according to an embodiment of the present disclosure may include a stage 700, a housing 300, an electron gun 310, a condenser lens 320, an objective lens 340, a deflector 330, a first electron detector 410, a second electron detector 430, a computing system 100, a signal generator 200, a signal converter 500, and a delay generator 600.

The stage 700 may receive the substrate W. Here, the substrate W may have a circular plate shape. However, this is illustrative, and the stage 700 may receive substrates W having various shapes.

The stage 700 may safely or securely fix the substrate W such that the substrate W is not shaken. The stage 700 may fix or support the substrate W through vacuum pressure, electrostatic force, and/or external force according to Bernoulli's law. The stage 700 may allow the substrate W to be stably maintained even under various physical and/or chemical influences occurring in a semiconductor manufacturing process. The stage 700 may have, for example, a rectangular plate shape. The stage 700 may have a large area sufficient to receive the substrate W when compared to the substrate W.

The stage 700 may move horizontally. For example, the stage 700 may move along a plane parallel to the upper surface of the substrate W as inspection of the substrate W is performed. In addition, the stage 700 may also move vertically. For example, the stage 700 may move in a direction perpendicular to the upper surface of the substrate W. The stage 700 may control an inspection area of the substrate W by moving the substrate W.

In an embodiment, various actuators may be connected to the stage 700. The actuators may serve to move the stage 700. That is, the stage 700 may move through the actuators. The actuators may control both the horizontal movement of the stage 700 and the vertical movement of the stage 700. The actuators may include, for example, a linear motor that enables high-speed movement without friction, a piezoelectric actuator that enables precise movement in nanometers, and/or a ball screw capable of controlling precise movement at low speed.

The housing 300 may be an outer casing that accommodates components for emitting the electron beam EB. For example, the electron gun 310, the condenser lens 320, the objective lens 340, and the deflector 330 may be provided in the housing 300. As illustrated in FIG. 1, the housing 300 may have a hexagonal cross-section and may have a cylindrical shape having a decreasing cross-sectional area toward the bottom. However, the shape of the housing 300 is not limited thereto, and the housing 300 may have various shapes suitable for performing the function of a casing.

The electron gun 310 may be disposed in the housing 300. The electron gun 310 may be provided, for example, in an upper area of an inner space of the housing 300. The electron gun 310 may generate and emit the electron beam EB. For example, when the inspection of the substrate W is performed, the electron gun 310 may emit the electron beam EB onto the substrate W. Here, the wavelength of the electron beam EB may be determined by the energy of electrons emitted from the electron gun 310. For example, the electron beam EB may have a wavelength of several nanometers.

For example, the electron gun 310 may be of a cold field emission (CFE) type, a Schottky emission (SE) type, or a thermionic emission (TE) type. The electron gun 310 may generate the electron beam EB by applying energy greater than or equal to a work function to electrons contained in a solid material that is an electron source.

The condenser lens 320 may be disposed under the electron gun 310 in the housing 300. For example, the condenser lens 320 may be disposed on the path of the electron beam EB between the electron gun 310 and the stage 700.

The condenser lens 320 may focus the electron beam EB on the deflector 330. Accordingly, the controllability of the electron beam EB by the deflector 330 may be improved.

The objective lens 340 may be disposed under the electron gun 310 in the housing 300. For example, the objective lens 340 may be disposed under the condenser lens 320. The objective lens 340 may be disposed on the path of the electron beam EB between the deflector 330 and the stage 700.

The objective lens 340 may adjust the focus of the electron beam EB. For example, the objective lens 340 may focus the electron beam EB on the substrate W. When the inspection of the substrate W is performed, the objective lens 340 may improve the accuracy in the inspection of the substrate W by focusing the electron beam EB on one area of the substrate W.

The deflector 330 may be disposed under the condenser lens 320 in the housing 300. For example, the deflector 330 may be provided between the electron gun 310 and the objective lens 340. The deflector 330 may be disposed on the path of the electron beam EB between the condenser lens 320 and the stage 700.

The deflector 330 may deflect the electron beam EB emitted from the electron gun 310. That is, the deflector 330 may deflect the path of the electron beam EB. Specifically, the deflector 330 may deflect the path of the electron beam EB such that the electron beam EB transmits through the condenser lens 320 and the objective lens 340 and is emitted onto one area of the substrate W. For example, the deflector 330 may be of an electric type or a magnetic type.

The deflector 330 may control an inspection area where the inspection of the substrate W is performed, by deflecting the electron beam EB. Accordingly, the substrate inspection apparatus 10 may inspect the substrate W as the stage 700 moves the substrate W or the deflector 330 deflects the electron beam EB emitted onto the substrate W.

The first electron detector 410 may be disposed on one side of the housing 300. The first electron detector 410 may detect the secondary electrons SE. For example, when the inspection of the substrate W is performed, the first electron detector 410 may detect the secondary electrons SE emitted from the substrate W. The first electron detector 410 may generate a first analog signal based on a result obtained by detecting the secondary electrons SE.

The second electron detector 430 may be disposed under the housing 300. For example, the second electron detector 430 may be provided between the housing 300 and the stage 700. The second electron detector 430 may detect the backscattered electrons BSE. For example, when the inspection of the substrate W is performed, the second electron detector 430 may detect the backscattered electrons BSE emitted from the substrate W. The second electron detector 430 may generate a second analog signal based on a result obtained by detecting the backscattered electrons BSE.

The signal converter 500 may be connected with the first electron detector 410 and/or the second electron detector 430. The signal converter 500 may convert an analog signal transferred from the first electron detector 410 and/or the second electron detector 430 into a digital signal when the inspection of the substrate W is performed.

For example, the signal converter 500 may convert the first analog signal into a first digital signal. For example, the signal converter 500 may convert the second analog signal into a second digital signal. For example, the signal converter 500 may recognize the first analog signal and the second analog signal and may convert the first analog signal and the second analog signal into one digital signal.

The signal generator 200 may be connected with the signal converter 500. The signal generator 200 may be connected with the deflector 330. The signal generator 200 may generate a reference signal to control operation of the signal converter 500 and the deflector 330.

More specifically, the signal generator 200 may transfer the reference signal to the signal converter 500. The signal converter 500 may convert the first analog signal and/or the second analog signal transferred from the first electron detector 410 and/or the second electron detector 430 into a digital signal through the reference signal transferred from the signal generator 200.

In addition, the signal generator 200 may transfer the reference signal to the deflector 330. The deflector 330 may control the degree of deflection of the electron beam EB through the reference signal transferred from the signal generator 200.

In an embodiment, the reference signal may have a constant period. That is, the signal generator 200 may generate the reference signal having the constant period. Accordingly, the operation of the signal converter 500 and the deflector 330 may be controlled at the constant period. As a result, the inspection of the substrate W may be performed at a constant speed.

The delay generator 600 may be connected between the signal generator 200 and the signal converter 500. The delay generator 600 may be connected with the signal generator 200 and the signal converter 500. The delay generator 600 may generate a delayed reference signal. The delayed reference signal may be a signal obtained by applying a delay value to the reference signal transferred from the signal generator 200. That is, the delay generator 600 may delay the reference signal.

For example, the delay generator 600 may generate the delayed reference signal and may transfer the delayed reference signal to the signal converter 500. Accordingly, the operation of the signal converter 500 may be delayed.

The computing system 100 may be connected with the signal converter 500. The computing system 100 may receive a digital signal from the signal converter 500. For example, the computing system 100 may receive the first digital signal and/or the second digital signal from the signal converter 500. The computing system 100 may obtain an image by analyzing the digital signal. For example, the computing system 100 may obtain a pattern image for patterns P of the substrate W by analyzing the first digital signal and/or the second digital signal.

The computing system 100 may be connected with the delay generator 600. For example, the computing system 100 may calculate a delay value by analyzing the pattern image and may transmit the delay value to the delay generator 600.

In an embodiment, the computing system 100 may include a processor 110 and a storage device 130. The processor 110 may be a computing device such as a work station computer, a desktop computer, a laptop computer, or a tablet computer. The processor 110 may be provided in plural. The processors 110 may be implemented with separate hardware or may be separate software included in a single piece of hardware.

The processor 110 may be a simple controller, a microprocessor, a complex processor such as a CPU or a GPU-9, a processor implemented by software, dedicated hardware, or firmware. The processor 110 may be implemented by, for example, a general-purpose computer or application-specific hardware such as a digital signal processor (DPS), a field programmable gate array (FPGA), or an application specific integrated circuit (ASIC).

In an embodiment, the processor 110 may analyze a digital signal transferred from the signal converter 500 to generate the pattern image and may analyze data of the pattern image to calculate a delay value corresponding thereto. For example, the processor 110 may analyze the first digital signal and/or the second digital signal to generate the pattern image and may analyze data of the pattern image to calculate a delay value corresponding thereto.

The storage device 130 may store data for implementing operation of the processor 110 or may store a data processing result of the processor 110. For example, the operation of the processor 110 may be implemented by the data stored in the storage device. Here, the storage device may include any mechanism for storing and/or transmitting information in a form readable by a machine (e.g., a computing device). For example, the storage device may include read only memory (ROM), random access memory (RAM), a magnetic disk storage device, an optical storage device, or a flash memory device.

In an embodiment, the storage device 130 may store data of the pattern image generated by the processor 110. In addition, the storage device 130 may store the delay value calculated by the processor 110.

Meanwhile, an operation process of generating an inspection error correction graph by the substrate inspection apparatus according to an embodiment of the present disclosure will be described below.

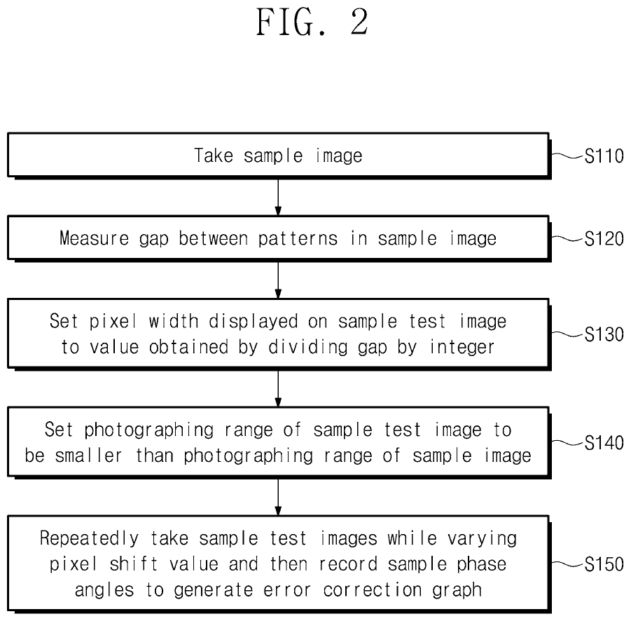

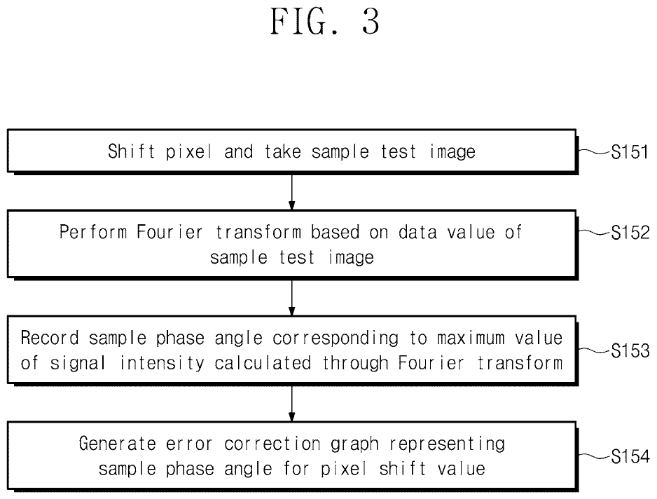

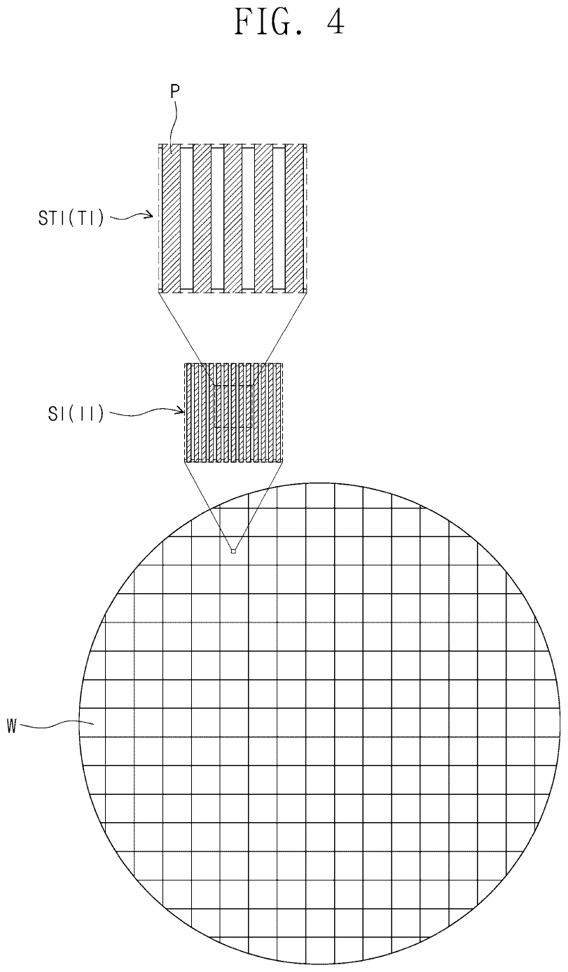

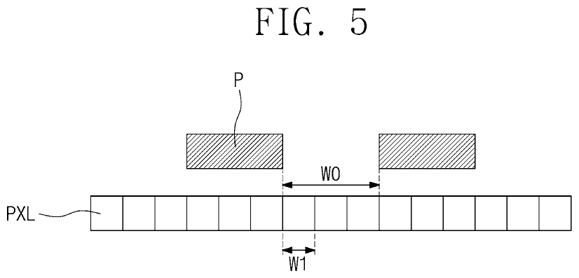

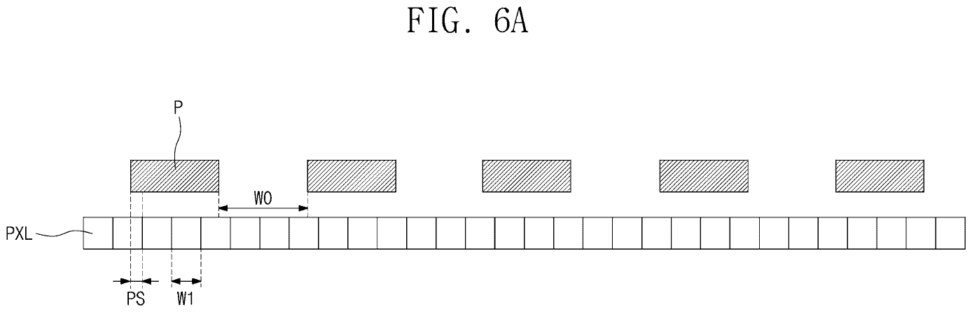

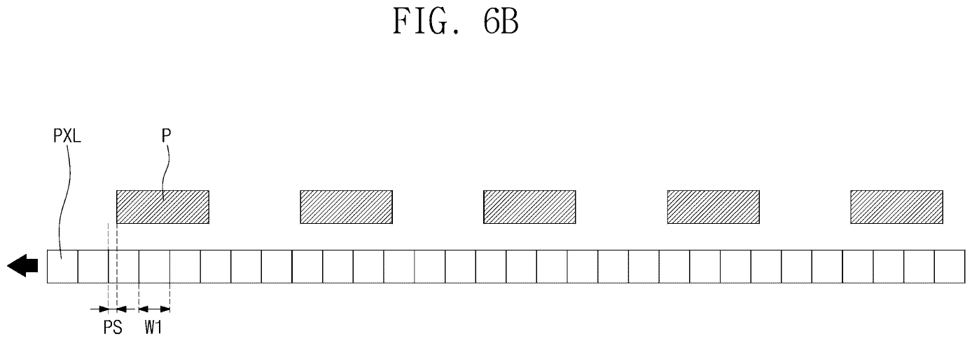

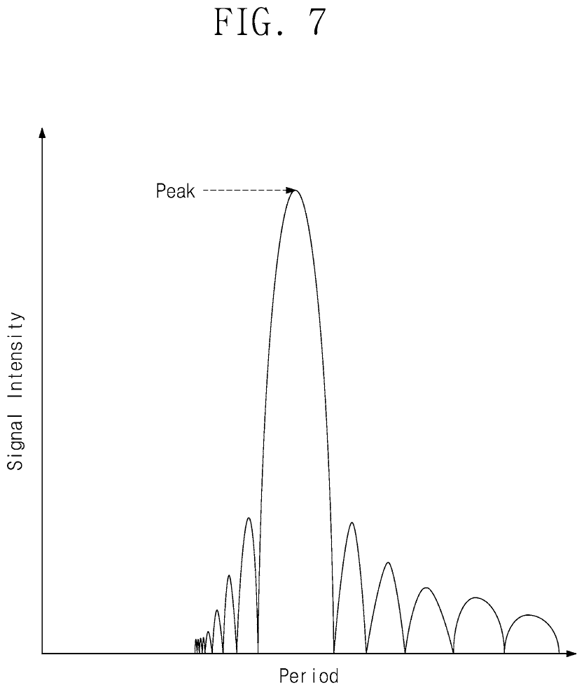

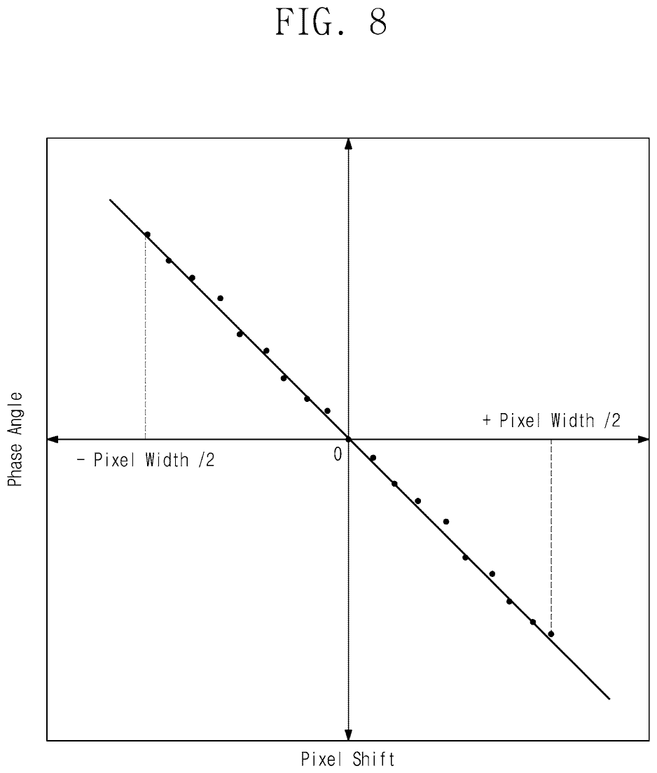

FIG. 2 is a flowchart for explaining an operation process of the substrate inspection apparatus according to an embodiment of the present disclosure. FIG. 3 is a flowchart for explaining an operation process of the substrate inspection apparatus according to an embodiment of the present disclosure. FIG. 4 is a view illustrating images taken by the substrate inspection apparatus according to an embodiment of the present disclosure. FIG. 5 is a view illustrating a portion of an image analyzed by the substrate inspection apparatus according to an embodiment of the present disclosure. FIGS. 6A and 6B are views illustrating a pixel shift process of the substrate inspection apparatus according to an embodiment of the present disclosure. FIG. 7 is a graph calculated by the substrate inspection apparatus according to an embodiment of the present disclosure. FIG. 8 is a graph calculated by the substrate inspection apparatus according to an embodiment of the present disclosure.

Referring to FIGS. 2 to 8, first, the substrate inspection apparatus 10 may take a sample image SI (S110). For example, the substrate inspection apparatus 10 may take an image of patterns P of one area of the substrate W. The substrate inspection apparatus 10 may take the image by emitting the electron beam EB onto the one area of the substrate W.

More specifically, due to the emission of the electron beam EB, the secondary electrons SE and the backscattered electrons BSE may be emitted from the substrate W, and the first electron detector 410 and the second electron detector 430 may detect the secondary electrons SE and the backscattered electrons BSE, respectively.

The first electron detector 410 and the second electron detector 430 may generate the first analog signal and the second analog signal, respectively, and may transfer the first analog signal and the second analog signal to the signal converter 500. The first analog signal and the second analog signal may be converted into the first digital signal and the second digital signal, respectively, by the signal converter 500. The first digital signal and the second digital signal may be transferred to the computing system 100. The computing system 100 may analyze the first digital signal and the second digital signal and may generate the sample image SI as illustrated in FIG. 4.

After the sample image SI is generated, the computing system 100 may measure the gap W0 between the patterns P in the sample image SI as illustrated in FIG. 5 (S120).

Next, the computing system 100 may determine the effective width of pixels PXL of an image for inspection of measurement errors of the patterns P, based on the measurement result. Here, the pixels PXL may be a grid pattern displayed within images generated while the substrate inspection apparatus 10 performs an inspection, and the effective width of pixels PXL may be an aggregate or equivalent width of the pixels corresponding to the grid pattern. For example, the computing system 100 may set the pixel width W1 displayed on a sample test image STI to a value obtained by dividing the pattern gap W0 by an integer (S130). In addition, the computing system 100 may determine the effective width of the pixels PXL displayed on the sample test image STI as an integer multiple of the pattern gap W0.

Then, the computing system 100 may set the photographing range of the sample test image STI to be smaller than the photographing range of the sample image SI (S140). For example, the computing system 100 may limit the photographing range of the sample test image STI such that five patterns P are displayed on the sample test image STI. As a result, the speed at which the substrate inspection apparatus 10 inspects the substrate W may be improved.

Furthermore, the computing system 100 may repeatedly take sample test images STI while varying a pixel shift value PS and may then record sample phase angles to generate an error correction graph (S150).

More specifically, as illustrated in FIGS. 6A and 6B, the computing system 100 may shift the pixels PXL and may take the sample test image STI (S151).

In an embodiment, the delay generator 600 may control the shift of the pixels PXL. For example, the delay generator 600 may generate a delayed reference signal and may transfer the delayed reference signal to the signal converter 500.

More specifically, the computing system 100 may generate a delay value corresponding to the pixel shift value PS and may transmit the delay value to the delay generator 600. Here, as illustrated in FIG. 6A, the pixel shift value PS may mean the horizontal separation gap between one side surface of a pattern P closest to one pixel PXL among the plurality of pixels PXL displayed on the image and one side surface of the pixel PXL closest to the one side surface of the pattern P.

In an embodiment, the delay value may vary depending on the pixel shift values PS of the sample test images STI. In this case, the delay generator 600 may generate a delayed reference signal corresponding to the pixel shift value PS by applying the delay value to a reference signal transferred from the signal generator 200. Furthermore, the delay generator 600 may transfer the delayed reference signal to the signal converter 500 to shift the pixels PXL displayed on the sample test image STI.

After that, the computing system 100 may perform Fourier transform based on a data value of the sample test image STI (S152). For example, the computing system 100 may perform fast-Fourier transform (FFT).

The computing system 100 may record the signal intensity of the sample test image STI and the sample phase angle corresponding to the maximum value of the signal intensity through the Fourier transform (S153). For example, the computing system 100 may obtain data showing a signal period and a signal intensity corresponding to the signal period illustrated in FIG. 7 through FFT and may calculate a sample phase angle corresponding to a peak point that is the maximum value of the signal intensity.

The substrate inspection apparatus 10 may take a sample test image STI of the same area within the substrate W while varying the pixel shift value PS and may recalculate a sample phase angle corresponding thereto. Furthermore, the substrate inspection apparatus 10 may repeatedly perform the above-described process, and the computing system 100 may generate an error correction graph representing the sample phase angles corresponding to the pixel shift values PS (S154).

That is, the computing system 100 may analyze a plurality of sample test images STI obtained by repeatedly photographing the pixels PXL while shifting the pixels PXL by a constant gap and may generate the error correction graph illustrated in FIG. 8 based on the analysis result of the sample test images STI.

In an embodiment, the range of the pixel shift value PS of the sample test images STI for generating the error correction graph may vary. For example, the pixel shift value PS may range from −1/2 of the pixel width W1 to +1/2 of the pixel width W1.

The error correction graph generated according to the above-described sequence may be used to correct an inspection error of inspection images for inspection of the patterns P of the substrate W of the substrate inspection apparatus 10. Hereinafter, an automated inspection error correction operation process of the substrate inspection apparatus according to an embodiment of the present disclosure will be described.

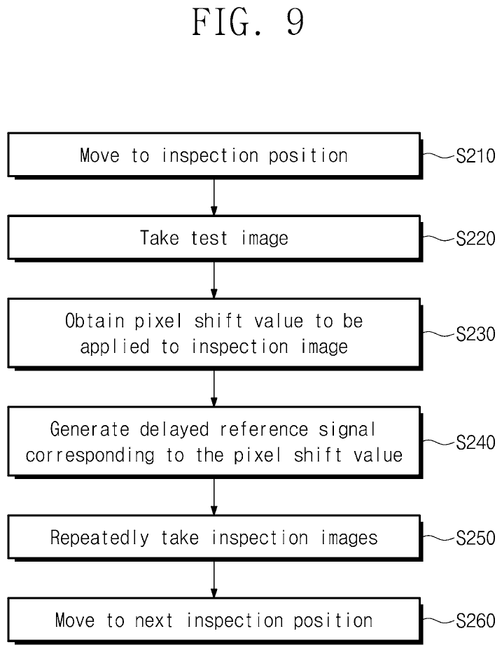

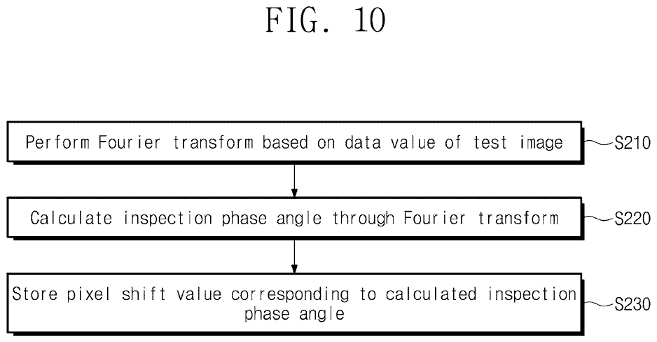

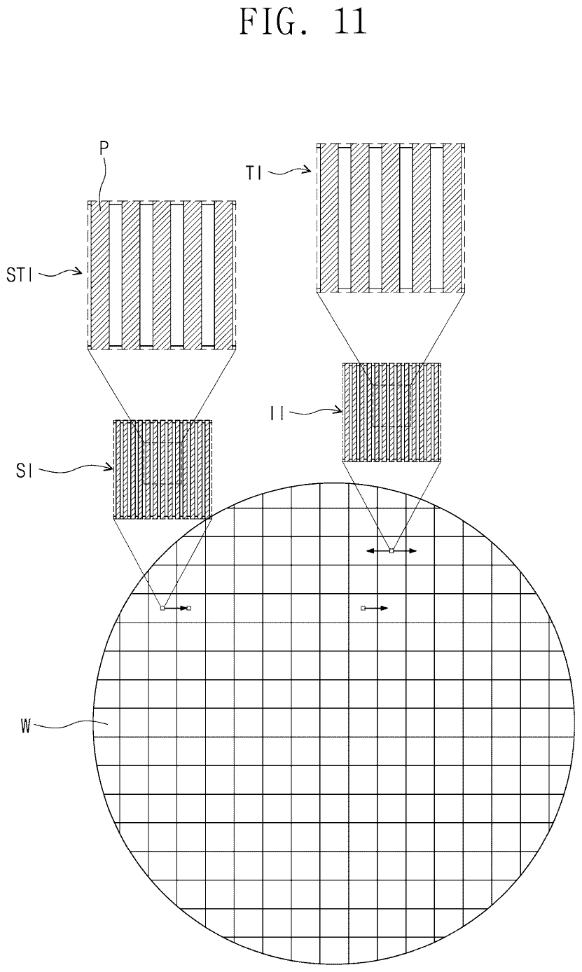

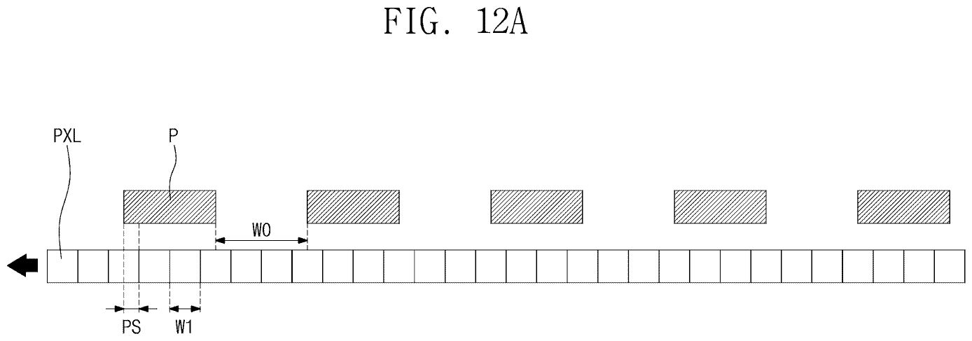

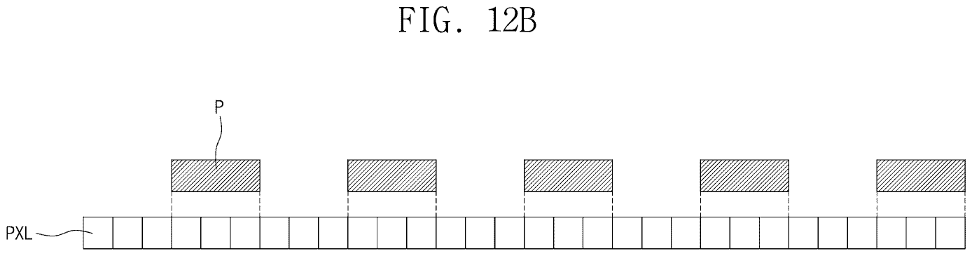

FIG. 9 is a flowchart for explaining an operation process of the substrate inspection apparatus according to an embodiment of the present disclosure. FIG. 10 is a flowchart for explaining an operation process of the substrate inspection apparatus according to an embodiment of the present disclosure. FIG. 11 is a view illustrating images taken by the substrate inspection apparatus according to an embodiment of the present disclosure. FIGS. 12A and 12B are views illustrating a pixel shift process of the substrate inspection apparatus according to an embodiment of the present disclosure.

Referring to FIGS. 9 to 12B, through a horizontal movement of the stage 700 (refer to FIG. 1), the substrate W may be moved to an inspection position (S210). Thereafter, the substrate inspection apparatus 10 may take a test image TI (S220). For example, the substrate inspection apparatus 10 (refer to FIG. 1) may take an image of patterns of another area other than the one area where the sample test image STI of the substrate W is taken. Next, the computing system 100 (refer to FIG. 1) may analyze the test image TI and may obtain a pixel shift value PS to be used for an inspection image II (S230).

In an embodiment, as illustrated in FIG. 11, the photographing range of the test image IT may be substantially the same as the photographing range of the sample test image STI. Furthermore, as illustrated in FIG. 12A, the pixel width W1 and/or the effective width of pixels PXL displayed on the test image TI may be substantially the same as those of the sample test image STI. Accordingly, the computing system 100 (refer to FIG. 1) may directly apply the error correction graph generated by analyzing the sample test images STI to the measurement of the pixel shift value PS of the test image TI.

More specifically, the computing system 100 (refer to FIG. 1) may perform Fourier transform based on a data value of the test image TI (S231). For example, the computing system 100 (refer to FIG. 1) may perform fast-Fourier transform (FFT).

The computing system 100 (refer to FIG. 1) may calculate the signal intensity of the test image TI and the inspection phase angle corresponding to the maximum value of the signal intensity of the test image TI through the Fourier transform (S232). For example, the computing system 100 (refer to FIG. 1) may obtain data on the signal period of the test image TI and the signal intensity of the test image TI corresponding to the signal period of the test image TI through FFT and may calculate the inspection phase angle corresponding to the peak point at which the signal intensity of the test image TI has a maximum value.

In addition, the computing system 100 (refer to FIG. 1) may store the pixel shift value PS corresponding to the inspection phase angle (S233). For example, the computing system 100 (refer to FIG. 1) may store the pixel shift value PS corresponding to the inspection phase angle on the error correction graph.

Thereafter, the delay generator 600 (refer to FIG. 1) may generate a delayed reference signal corresponding to the stored pixel shift value PS (S240). Specifically, after the pixel shift value PS is stored, the computing system 100 (refer to FIG. 1) may transmit a delay value corresponding to the pixel shift value PS to the delay generator 600 (refer to FIG. 1). In this case, the delay generator 600 (refer to FIG. 1) may generate the delayed reference signal corresponding to the pixel shift value PS by applying the delay value to a reference signal transferred from the signal generator 200 (refer to FIG. 1).

Furthermore, the delay generator 600 (refer to FIG. 1) may transfer the delayed reference signal to the signal converter 500 (refer to FIG. 1) to shift the pixels PXL displayed on the test image TI as illustrated in FIG. 12A. Due to this, as illustrated in FIG. 12B, the patterns P and the pixels PXL displayed on the test image TI may be aligned with a constant gap. As a result, a gray level deviation of an image caused by misalignment of the patterns P and the pixels PXL may be improved. In addition, an inspection error of the substrate inspection apparatus 10 (refer to FIG. 1) caused by the gray level deviation may be reduced.

After the shift operation of the pixels PXL through the test image TI is performed, the substrate inspection apparatus 10 (refer to FIG. 1) may repeatedly take inspection images II for inspecting the patterns P of the substrate W.

More specifically, the substrate inspection apparatus 10 (refer to FIG. 1) may take the inspection images II by directly applying the pixel shift value PS obtained by analyzing the test image TI. That is, the substrate inspection apparatus 10 (refer to FIG. 1) may inspect the patterns P of the substrate W based on the inspection images II repeatedly taken by applying the pixel shift value PS.

As illustrated in FIG. 11, the substrate inspection apparatus 10 (refer to FIG. 1) may take the inspection images II by changing the photographing area of the substrate W at a constant interval. In this case, the deflector 330 (refer to FIG. 1) may finely adjust the emission range of the electron beam EB (refer to FIG. 1). For example, the deflector 330 may deflect the electron beam EB to a range of several tens of micrometers while the housing 300 is fixed. In an embodiment, the photographing range of the inspection images II may be substantially the same as the photographing range of the sample image SI.

Thereafter, the substrate inspection apparatus 10 (refer to FIG. 1) may move to the next inspection position of the substrate W (S260). Specifically, the stage 700 (refer to FIG. 1) may move to the next inspection position. Accordingly, the substrate inspection apparatus 10 (refer to FIG. 1) may inspect patterns P of another area of the substrate W.

In this case, the substrate inspection apparatus 10 (refer to FIG. 1) may repeatedly perform the above-described automated inspection error correction operation as the stage 700 (refer to FIG. 1) moves. For example, the substrate inspection apparatus 10 (refer to FIG. 1) may calculate a pixel shift value PS of a test image TI of the other area of the substrate based on the error correction graph, and the delay generator 600 (refer to FIG. 1) may transfer a delayed reference signal corresponding to the pixel shift value PS to correct an inspection error of inspection images II of the other area.

The substrate inspection apparatus 10 (refer to FIG. 1) may end the above-described operations when patterns P of all areas of the substrate W are completely inspected.

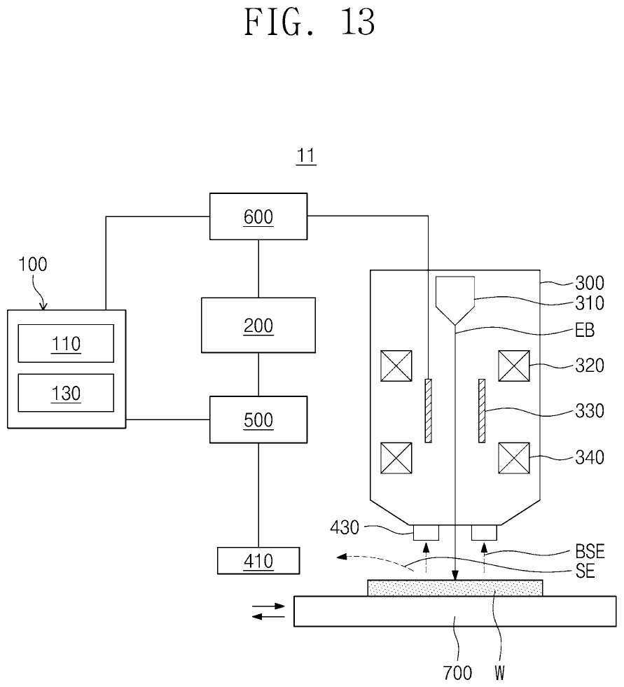

FIG. 13 is a sectional view of a substrate inspection apparatus 11 according to an embodiment of the present disclosure. For convenience of description, the following description will be focused on differences from the above-described embodiment.

In an embodiment, a delay generator 600 may be connected between a signal generator 200 and a deflector 330. In this case, the delay generator 600 may control a reference signal that controls operation of the deflector 330.

More specifically, a computing system 100 may analyze a pattern image for patterns of a substrate W to calculate a delay value and may transmit the delay value to the delay generator 600. The delay generator 600 may generate a delayed reference signal by applying the delay value to the reference signal transferred from the signal generator 200.

In addition, the delay generator 600 may transfer the delayed reference signal to the deflector 330. Accordingly, the delay generator 600 may control the degree of deflection of an electron beam EB by the deflector 330. As a result, the delay generator 600 may control the degree of shift of pixels PXL (refer to FIG. 12A) displayed on an image.

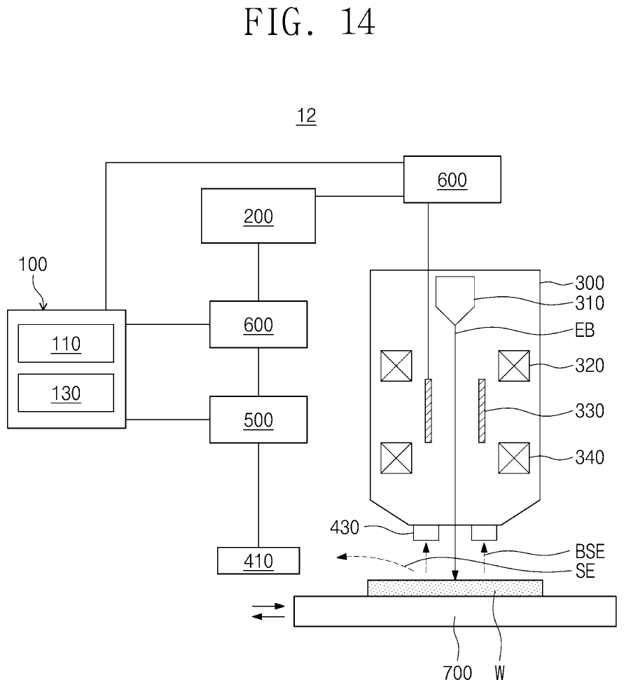

FIG. 14 is a sectional view of a substrate inspection apparatus 12 according to an embodiment of the present disclosure. For convenience of description, the following description will be focused on differences from the above-described embodiment.

In an embodiment, a delay generator 600 may be connected between a signal generator 200 and a deflector 330 and between the signal generator 200 and a signal converter 500. In this case, the delay generator 600 may be provided in plural. The delay generator 600 may control both operation of the deflector 330 and operation of the signal converter 500.

As a result, the delay generator 600 may control the degree of shift of pixels PXL (refer to FIG. 12A) displayed on an image.

The substrate inspection apparatuses according to the embodiments of the present disclosure may reduce an inspection error.

The substrate inspection apparatuses according to the embodiments of the present disclosure may automate correction of an inspection error.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A substrate inspection apparatus comprising:
a stage configured to receive a substrate;
a housing provided over the stage;
an electron gun disposed in the housing and configured to emit an electron beam onto the substrate;
an objective lens disposed under the electron gun in the housing and configured to adjust a focus of the electron beam;
a deflector provided between the electron gun and the objective lens and configured to deflect a path of the electron beam;
a first electron detector disposed on one side of the housing and configured to generate a first analog signal based on a result obtained by detecting secondary electrons emitted from the substrate by the electron beam;
a signal converter connected with the first electron detector and configured to convert the first analog signal into a first digital signal;
a signal generator connected with the signal converter and the deflector and configured to generate a reference signal to control operation of the signal converter and the deflector; and
a delay generator configured to delay the reference signal.

2. The substrate inspection apparatus of claim 1, further comprising:
a second electron detector disposed between the housing and the stage and configured to detect backscattered electrons scattered from the substrate by the electron beam,
wherein the second electron detector is configured to generate a second analog signal based on a result obtained by detecting the backscattered electrons, and
wherein the signal converter is configured to convert the second analog signal into a second digital signal.

3. The substrate inspection apparatus of claim 2, further comprising:
a computing system configured to obtain a pattern image for patterns of the substrate by analyzing the first digital signal and the second digital signal converted by the signal converter.

4. The substrate inspection apparatus of claim 3, wherein the computing system includes:
a processor configured to calculate a delay value by analyzing data of the pattern image; and
a storage device configured to store the data of the pattern image, and
wherein the computing system transmits the delay value to the delay generator.

5. The substrate inspection apparatus of claim 4, wherein the delay generator is connected between the signal generator and the signal converter, and
wherein the delay generator is configured to generate a delayed reference signal by delaying the reference signal based on the delay value and transfer the delayed reference signal to the signal converter.

6. The substrate inspection apparatus of claim 4, wherein the delay generator is connected between the signal generator and the deflector, and
wherein the delay generator is configured to generate a delayed reference signal by delaying the reference signal based on the delay value and transfer the delayed reference signal to the deflector.

7. The substrate inspection apparatus of claim 4, wherein the computing system analyzes a sample image obtained by photographing patterns of one area of the substrate and measures a pattern gap between the patterns, and
wherein the computing system is configured to determine an effective width of pixels of an image for inspection of a measurement error of the patterns, based on the measurement result.

8. The substrate inspection apparatus of claim 7, wherein the computing system is configured to determine the effective width of the pixels as an integer multiple of the pattern gap.

9. The substrate inspection apparatus of claim 7, wherein the computing system analyzes a plurality of sample test images obtained by repeatedly photographing the pixels while shifting the pixels by a constant gap after the measurement of the pattern gap is performed, and
wherein the computing system is configured to calculate each sample phase angle based on a result obtained by analyzing the sample test images.

10. The substrate inspection apparatus of claim 9, wherein the delay generator is configured to control the shifting of the pixels by generating a delayed reference signal, and
wherein the delay value varies depending on a shift value of pixels of the sample test images.

11. The substrate inspection apparatus of claim 9, wherein a photographing range of the sample test images is set to be smaller than a photographing range of the sample image.

12. The substrate inspection apparatus of claim 9, wherein a shift value of the pixels ranges from −1/2 of a pixel width to +1/2 of the pixel width.

13. The substrate inspection apparatus of claim 9, wherein the computing system is configured to generate an error correction graph representing sample phase angles for shift values of the pixels.

14. The substrate inspection apparatus of claim 13, wherein the computing system calculates an inspection phase angle by analyzing a test image obtained by photographing patterns of another area of the substrate, and
wherein the computing system is configured to store a pixel shift value corresponding to the inspection phase angle on the error correction graph.

15. The substrate inspection apparatus of claim 14, wherein a photographing range of the test image is set to be substantially the same as a photographing range of the sample test image.

16. The substrate inspection apparatus of claim 14, wherein the computing system is configured to transmit a delay value corresponding to the pixel shift value to the delay generator after the pixel shift value is stored.

17. The substrate inspection apparatus of claim 14, wherein the computing system is configured to inspect the patterns of the substrate based on inspection images repeatedly taken by applying the pixel shift value after the pixel shift value is stored.

18. A substrate inspection apparatus comprising:
a stage configured to receive a substrate;
a housing provided over the stage;
an electron gun disposed in the housing and configured to emit an electron beam onto the substrate;
an objective lens disposed under the electron gun in the housing and configured to adjust a focus of the electron beam;
a deflector provided between the electron gun and the objective lens and configured to deflect a path of the electron beam;
a first electron detector disposed on one side of the housing and configured to generate a first analog signal based on a result obtained by detecting secondary electrons emitted from the substrate by the electron beam;
a signal converter connected with the first electron detector and configured to convert the first analog signal into a first digital signal;
a signal generator connected with the signal converter and the deflector and configured to generate a reference signal to control operation of the signal converter and the deflector;
a computing system connected with the signal converter and configured to obtain a pattern image for patterns of the substrate; and
a delay generator connected between the signal generator and the signal converter and between the signal generator and the deflector,
wherein the delay generator is configured to transfer a delayed reference signal to the signal converter and the deflector.

19. The substrate inspection apparatus of claim 18, wherein the computing system generates an error correction graph by analyzing sample test images obtained by repeatedly photographing patterns of one area of the substrate,
wherein the computing system stores pixel shift values of inspection images for inspection of the patterns of the substrate based on the error correction graph, and
wherein the delay generator is configured to generate a delayed reference signal corresponding to the pixel shift values.

20. A substrate inspection apparatus comprising:
a stage configured to receive a substrate;
a housing provided over the stage;
an electron gun disposed in the housing and configured to emit an electron beam onto the substrate;
an objective lens disposed under the electron gun in the housing and configured to adjust a focus of the electron beam;
a deflector provided between the electron gun and the objective lens and configured to deflect a path of the electron beam;
a first electron detector disposed on one side of the housing and configured to detect secondary electrons emitted from the substrate by the electron beam;
a second electron detector disposed between the housing and the stage and configured to detect backscattered electrons scattered from the substrate by the electron beam;
a signal converter connected with the first electron detector and the second electron detector;
a signal generator connected with the signal converter and the deflector and configured to generate a reference signal having a constant period to control operation of the signal converter and the deflector;
a computing system connected with the signal converter and configured to obtain a pattern image for patterns of the substrate; and
a delay generator connected between the signal generator and the deflector or between the signal generator and the signal converter,
wherein the computing system generates an error correction graph by analyzing sample test images obtained by repeatedly photographing patterns of one area of the substrate,
wherein the computing system stores pixel shift values of inspection images for inspection of the patterns of the substrate based on the error correction graph, and
wherein the delay generator is configured to generate delayed reference signals corresponding to the pixel shift values.
